(19) United States
(12) Patent Application Publication
(10) Pub. No.: US 2002/0161772 A1
(43) Pub. Date: Oct. 31, 2002

(54) Automated procedure for database creation for a form-based data collection system

(76) Inventors: Alan P. Bergelson, Ridgewood, NJ (US); Alexander D. Boyce, Oakland, NJ (US)

Correspondence Address: PENNIE AND EDMONDS, 1155 AVENUE OF THE AMERICAS, NEW YORK, NY, 100362711

(21) Appl. No.: 10/081,006

(22) Filed: Feb. 20, 2002

Related U.S. Application Data
(60) Provisional application No. 60/269,807, filed on Feb. 20, 2001.

(51) Int. Cl. G06F 7/00

(52) U.S. Cl. 707/100

(57) ABSTRACT

A preferred embodiment of the present invention comprises a method for creating a database for a form-based data collection system, comprising the steps of receiving from a user a document comprising data regarding shapes or graphical objects associated with information comprising one or more of the following: data type, data field size, and field location; and populating a database from the information, using the data. Preferably, the shapes or graphical objects are dragged and dropped into the document. Typically, the document comprises a plurality of pages, and the method comprises creating a form using information associated with each page. In one embodiment, each form includes a form number. Typically, the form also includes a form identification bubble. Preferably, after the forms are created, they are emailed to the user. Software for performing the above steps in an automated manner is also disclosed.

### CROSS-REFERENCE TO PROVISIONAL APPLICATION

This application claims the benefit of U.S. Provisional Application No. 60/269,807, filed Feb. 20, 2001.

### BACKGROUND OF THE INVENTION

The present invention relates to an automated process for the creation of a database for a paper form-based data collection system.

In order for a form-based data collection system to capture data from users, a database must be created with information that describes the data being collected from the user and the physical layout of the form the user is filling out. For the system to be successful, this process must be fast and easy to use.

In client server versions of some form-based data collection systems, the process of getting a form defined to the system is very manual. For example, forms might be created manually using CorelDraw and manually scanned into a computer database. All the information that describes the form and the information being collected might be manually keyed into various database tables. Because of database designs, some of the information might need to be entered multiple times. The total time for a form to be designed and for the database to be completed can be on the order of weeks or months.

### SUMMARY OF THE INVENTION

A preferred embodiment of the present invention comprises an automated method for creating a database for a form-based data collection system, comprising the steps of receiving from a user a document comprising data regarding shapes or graphical objects associated with information comprising one or more of the following: data type, data field size, and field location; and populating a database from the information, using the data. Preferably, the shapes or graphical objects are dragged and dropped into the document. Typically, the document comprises a plurality of pages, and the method comprises creating a form using information associated with each page. In one embodiment, each form includes a form number. Typically, the form also includes a form identification bubble (defined below). Preferably, after the forms are created, they are emailed to the user. Although those skilled in the art will recognize that other software could be used to create the document, a preferred embodiment uses Visio. Software for performing the above steps in an automated manner is also disclosed.

### BRIEF DESCRIPTION OF THE DRAWINGS

FIG. 1 is a workflow diagram providing an overview of steps of the present invention.

FIG. 2 illustrates load balancing.

FIGS. 3-5 provide a detailed workflow of steps of the invention.

FIG. 6 is a workflow diagram illustrating steps of a preferred form validity test procedure.

### DETAILED DESCRIPTION OF PREFERRED EMBODIMENTS

A preferred embodiment of the present invention comprises an automated process for the creation of a database for a paper form-based data collection system. The automated process is referenced herein as VI Joe. In this process, a user creates a form or forms, preferably using Microsoft Visio 2000 or equivalent software and a stencil.

Visio (or other analogous tools) allows for the creation and use of custom stencils which contain “normal” properties that pertain to and control Visio's visual/printed presentation of the object as seen by the user. It also allows these stencils to contain other custom properties which Visio itself ignores (though preserving these properties within the document file). These other properties, within objects built using the custom stencils, may be specified by a form designer in the process of building tailored objects using these stencils, and may subsequently be examined and/or manipulated by other software programs, such as VI-JOE.

In the preferred embodiment, custom stencils are provided which contain generic visual properties that pertain to the visual/physical layout of fields on a form's design (e.g., a date field, a field for entering Social Security Number, etc.). The stencils also contain properties that allow the form designer to specify other parameters of the given field which are related to the data storage, identification, and verification of the data subsequently entered onto the field by users of the printed form. Examples of these properties would include limiting a field's valid content to only include numbers (for SSN fields) or to limit a field's value to never exceed a particular value (e.g., a date field can never exceed 31).

The user of these custom stencils drags them onto a form page and adjusts them to visually create the form layout/design needed to capture the type of information that will be collected, using the “normal” properties, and then specifies the custom properties for each field to define the data storage, identification, and verification properties as needed to specify the proper database storage for the data collected in this field. Once all data fields have been completely specified, satisfying both the form layout needs (via “normal” properties) and data storage requirements (via the custom properties) the custom form document file is saved, and is then used in 2 ways: (a) it forms the visual design that is subsequently printed from within Visio to create the hard-copy form pages used to capture the handwritten data; and (b) it is submitted to VI-Joe via email (or other means) for processing and automatic creation of a database.

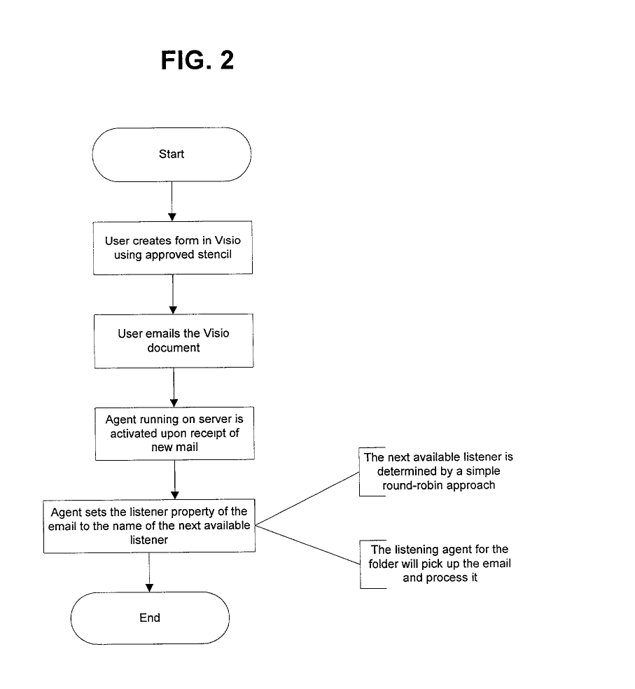

The email is sent to a public folder on an email server. An agent—a programming script that executes under specific conditions—is executed whenever new email is deposited in the VI Joe public folder. This agent preferably acts as a load balancer and assigns the email to a listener for processing. This assignment is done in a simple round robin fashion based on the number of listeners that are running. See FIG. 2. The number of listeners is based upon expected usage and desired response time.

A listener is a computer program that looks for email that has been assigned to it and processes the email. In a preferred embodiment, this processing has three components.

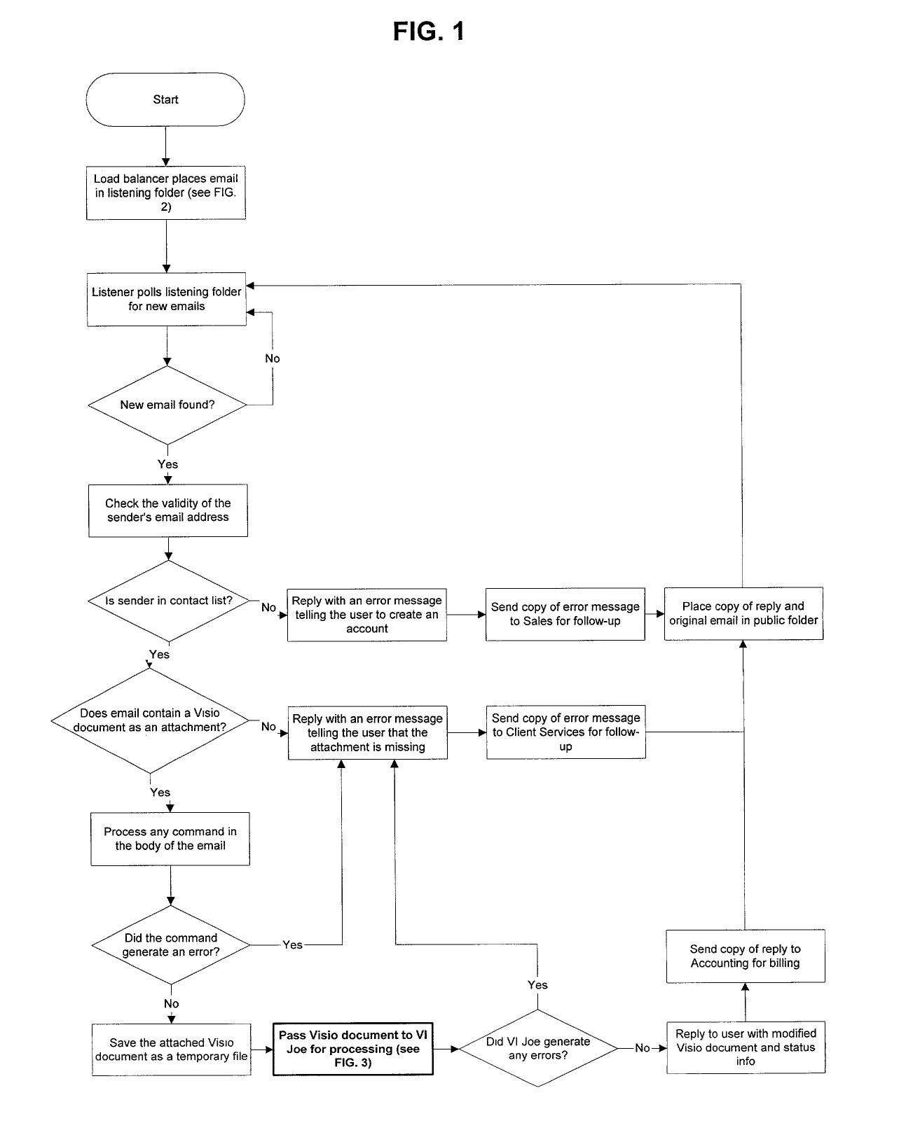

The first component—illustrated in FIG. 1—is to examine the return email address and verify that the user is authorized to submit forms to VI Joe. This is done by comparing the reply email address to a list of authorized users. If the user is not authorized, then an email is generated with an error message stating that the user is not authorized and that the user should set up an account. A sales or accounts department preferably also receives a copy of this email. If the user is authorized, then the processing continues.

The second processing component is to examine the text in the body of the email for commands. Any commands that are recognized are processed. Unrecognized commands are ignored. These commands allow a user to (a) define a set of users who will be able to use the form set being defined, (b) define the name of the form set, and (c) control certain aspects of the form processing.

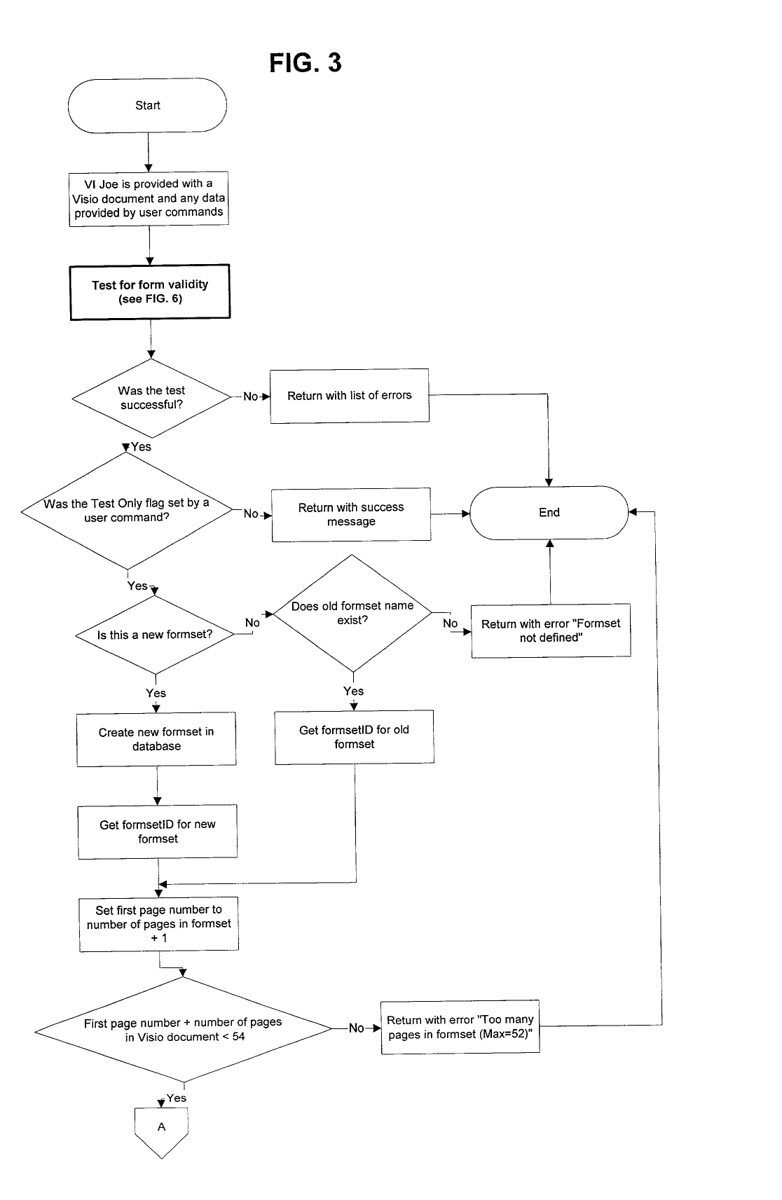

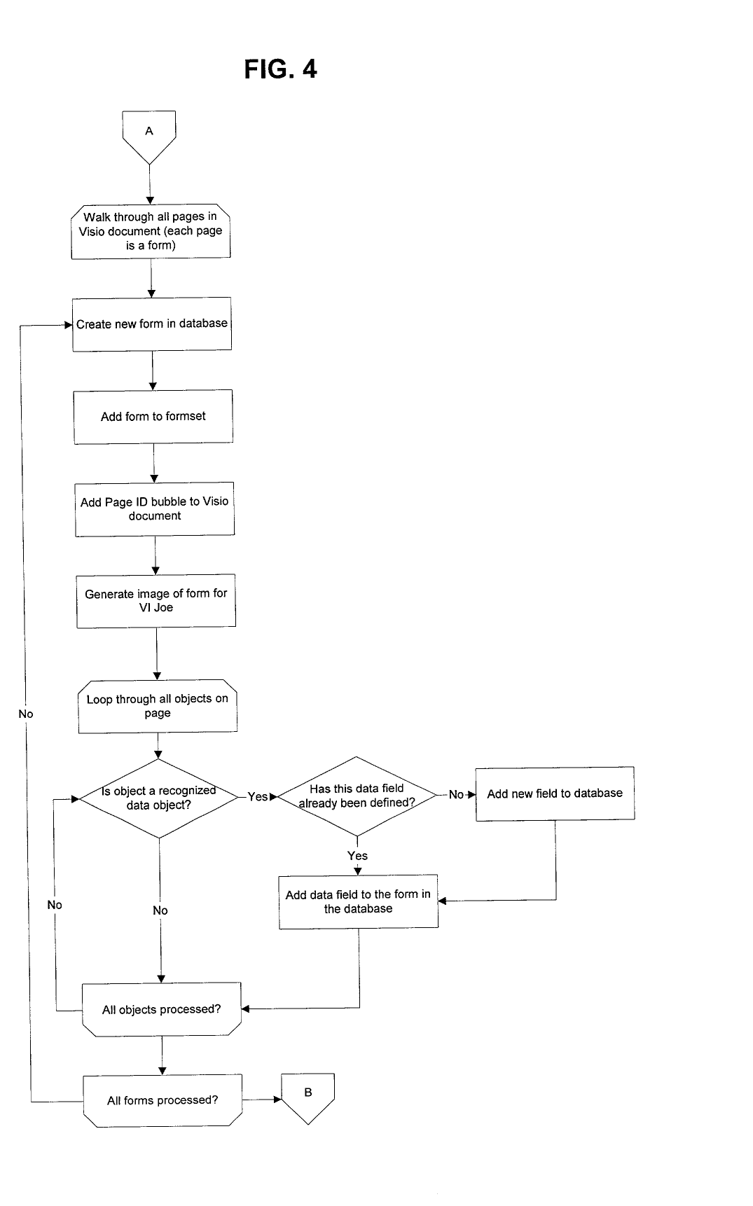

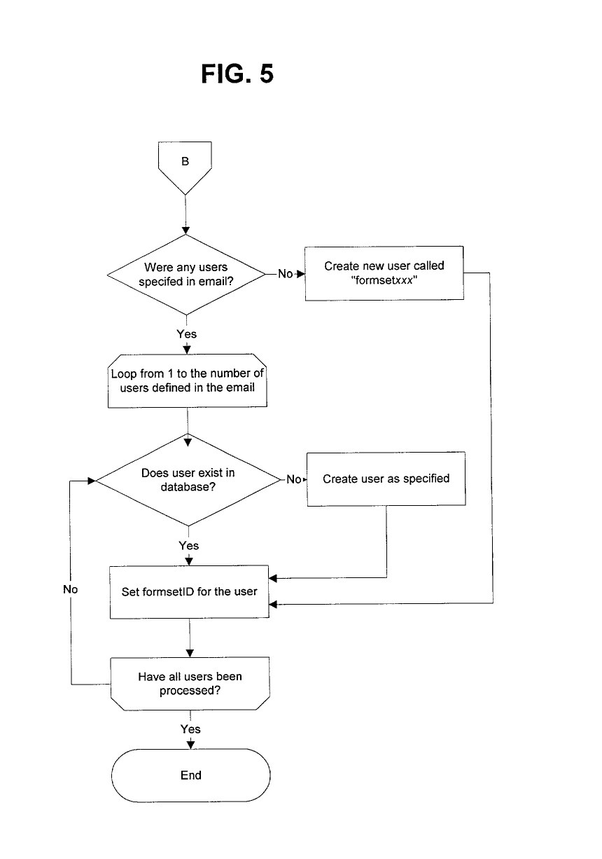

The third processing component is to process the contents (see FIGS. 3-5) of the attached Visio document itself, with each page of the Visio document defining a separate form/page within the formset, to verify the form design is valid, and then to extract the information from the custom fields to build the database.

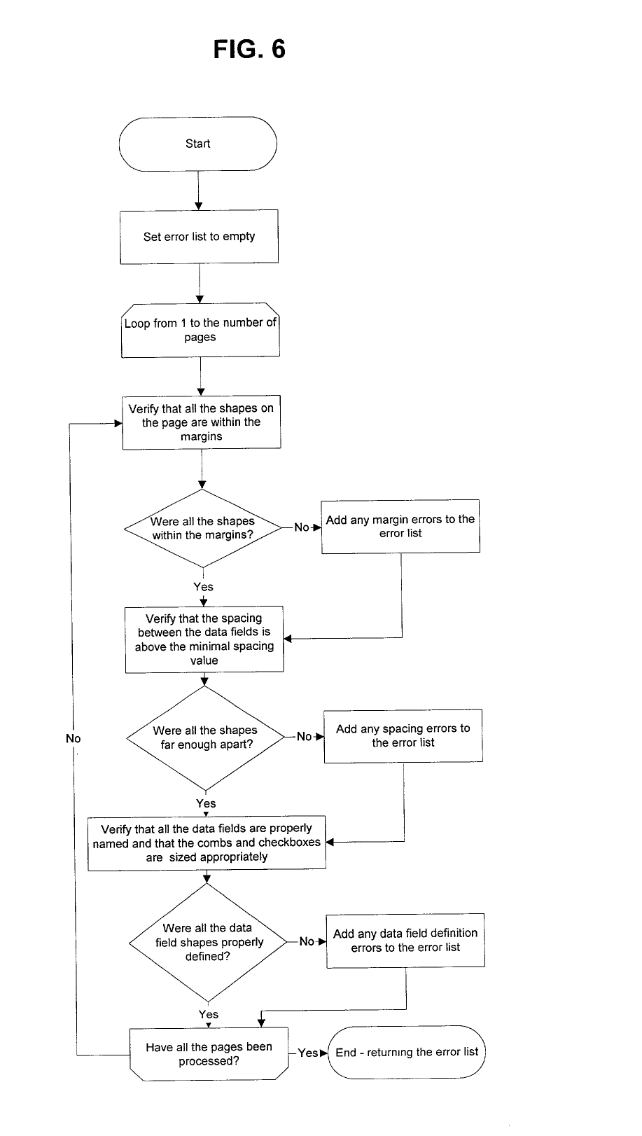

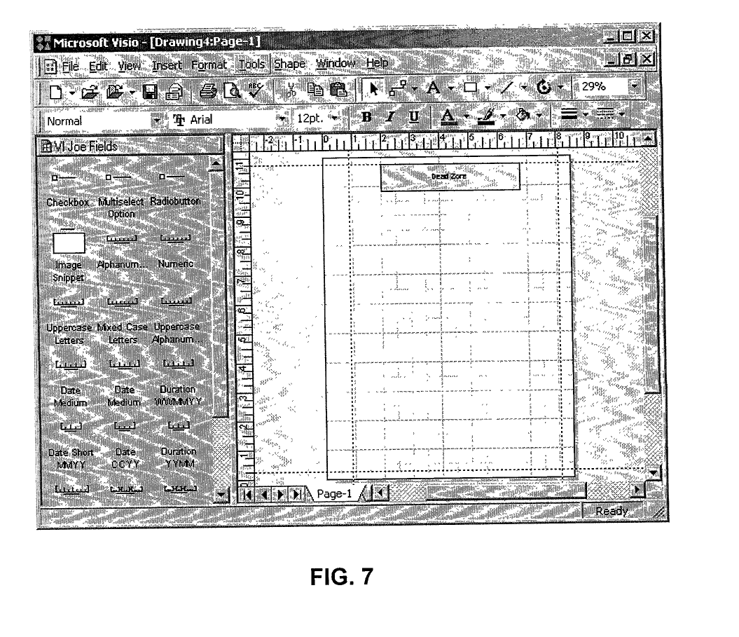

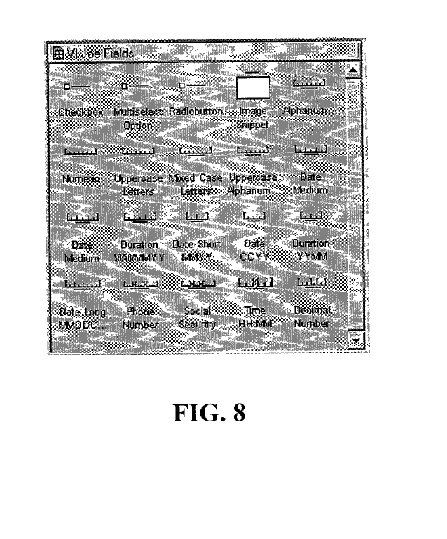

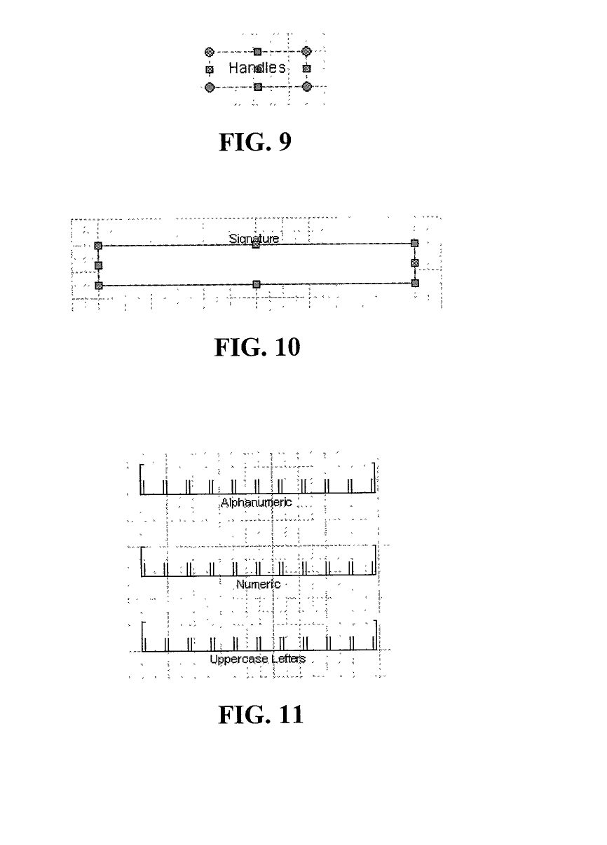

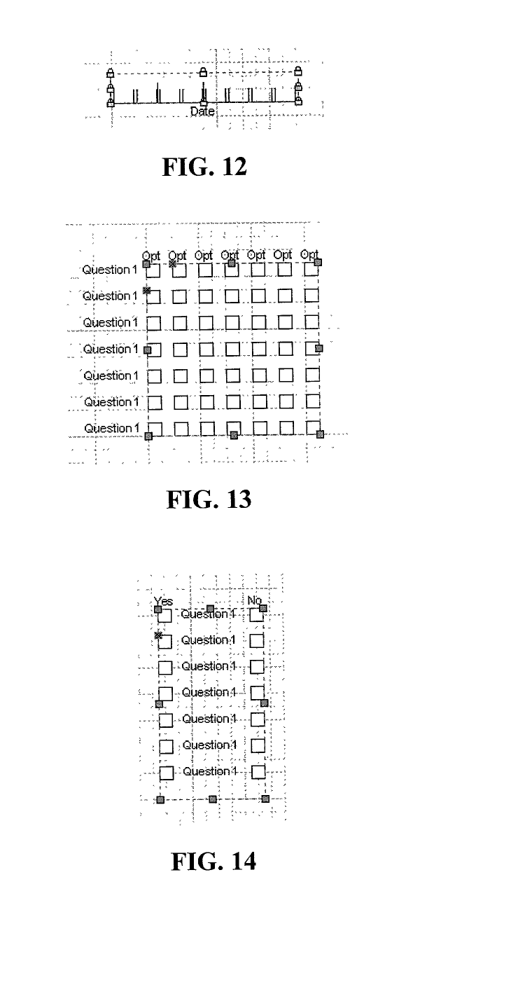

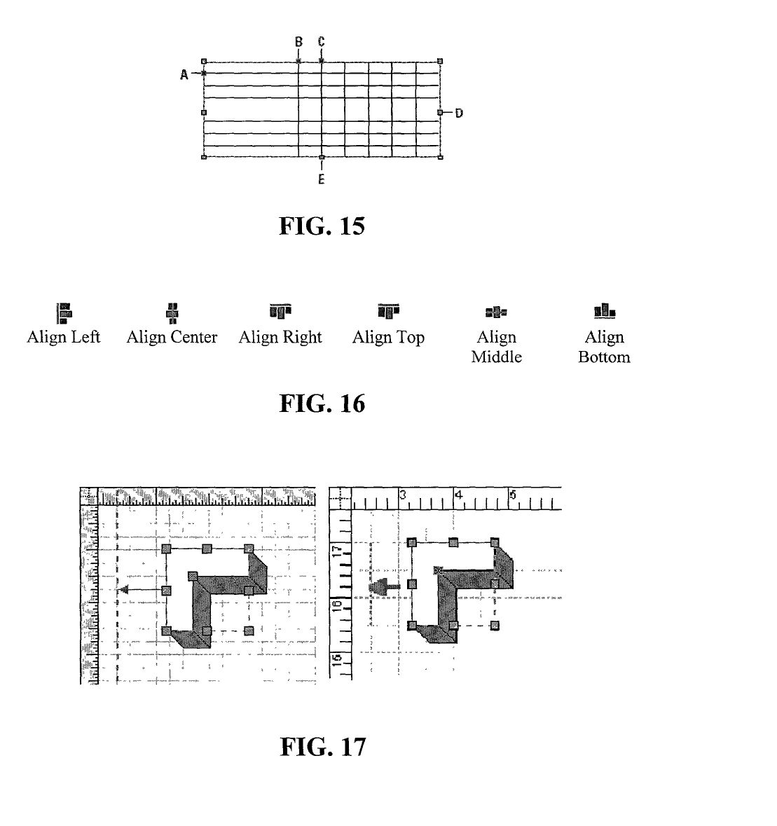

Initially, the locations of all fields are examined and compared to form limits and the locations of other fields to ensure that all objects are within the document's margins, not too close to each other, etc. After checking the form layout validity (see FIG. 6), the document is then further processed by examining each of the objects/fields in the document, extracting and examining the custom property values and verifying that these property values are both self-consistent (e.g., a field cannot contain letters and also be >25) and also that they specify unique data fields (e.g., a database cannot have 2 fields with the same name, etc.). Any errors that are discovered in this processing phase are recorded for subsequent report to the user.

If no errors are found in this stage of the processing, the database is created (or modified, if this is a form revision) for all of the forms and fields on those form pages, using the information extracted from the custom properties.

At the completion of processing, VI-Joe emails the user with the results of the processing, delivering either a list of errors, describing the nature of the offending properties, if any, or delivering the form ID allocated by VI-Joe for the newly created (or modified) formset.

If no errors are detected, then the Visio document is modified to create the appropriate forms. In one embodiment, the document is modified so that each page includes a form number and a Form Identification Bubble (an enclosed area intended to be filled in by a manually-made mark whose location can be used to identify the form). Preferably, the modified document is attached to the reply email so that the user can print it out for use with the paper-form-based data collection system.

Detailed description of stencil creation and usage

VI Joe is an application designed to create, in a quick and simple manner, forms and databases. This program allows users to create forms using Microsoft Visio and transfer those forms to VI Joe in a completely automated fashion. The following description is written in the format of a user manual, in order to fully illustrate the details of the preferred stencil creation and usage. Those skilled in the art will recognize how software code should be written to embody the described functionality.

Visio was chosen as the preferred software solution for a few reasons. First, it gives the user the ability to create the data collection objects that he/she will use in creating forms. The stencil capability of Visio was designed specifically for this purpose. Second, users can modify the appearance of certain aspects of their data elements—such as font size, style, and position—while preserving the database definition information underneath. Lastly, when clients supply an existing form that must be used, users can scan the paper into Visio and create an exact Visio representation of the document using the scanned image as a background for guidance. After the form is created, the background image can be removed, and the Visio file can then be submitted to VI JOE for processing. See FIG. 7.

Designing forms using a blank form stencil:

To open a VI JOE blank form:

1. Choose File, New, then VI JOE Blank Form. This drawing page contains margins and a Dead Zone.

2. Do not place data objects or fields outside the margins or inside the yellow Dead Zone.

To create a Checkbox:

1. Drag a Checkbox from the green Stencil in the left pane to the drawing page in the right pane. Do not place any item inside the Dead Zone.

2. To insert text next to the box, double-click on the description, then type the text.

To create a Multi-select Option or Radio Button:

1. Drag a Multi-select Option or Radio Button from the green Stencil in the left pane to the drawing page in the right pane. Do not place any item inside the Dead Zone.

2. To insert text next to the box, double-click on the description, then type the text.

3. To move a box, click inside the box and drag it to a new location within the margins. See FIG. 8.

Checkbox: A box that indicates something when marked.

Multi-Select Option: A group of boxes that allows the user to select more than one option.

Radio Button: A group of boxes that allows the user to select only one item of a group.

To group Multi-select Options or Radio Buttons:

1. Click the Pointer Tool (arrow) on the standard toolbar.

2. Drag a rectangle around the items that you want grouped.

3. Choose Shape, Grouping, then Group.

4. Name the group by clicking on the Text Tool (letter A) on the standard toolbar, then typing the group name.

5. Modify or move your group name by clicking F2, then dragging the text box to the desired position.

To move text (see FIG. 9):

1. Move your text by clicking F2, then dragging the text box to the desired position.

2. Expand or contract your text box vertically or horizontally by dragging the square green handle.

3. Rotate your text box by dragging the round green handle.

To create a name for an item different from the database name:

Normally, the database name for an element is the same as the field name. There may be times, however, when you will want to name your element something on the paper form, and something else in the database.

1. Select the element.

2. Delete the descriptive text (i.e., “Checkbox”, “Radio button”, etc.).

3. Choose Format, then Special.

4. Change the text in the Name field, then click OK.

5. Create the text you wish to appear on the paper form by clicking on the Text Tool (letter A) on the standard toolbar, then typing the group name.

6. Modify or move your group name by clicking F2, then dragging the text box to the desired position.

To insert text inside checkboxes:

1. Create the text you wish to appear inside the checkbox by clicking on the Text Tool (letter A) on the standard toolbar, then typing the text.

2. Choose Format, then Text to customize the font, size, color, or style of your text, then click Apply, then OK.

3. Modify or move your text by clicking F2, then dragging the text box to the desired position.

4. To group the text with the checkbox, click the Pointer Tool (arrow) on the standard toolbar, drag a rectangle around the items that you want grouped, then Choose Shape, Grouping, then Group.

To unlock sizing restrictions:

The size of some objects, such as a Social Security Number comb, cannot be altered. If you wish to alter these objects:

1. Select the object.

2. Choose Format, then Protection.

3. Clear the appropriate checkboxes.

To create a larger Context Zone:

1. Drag a rectangle around the data fields you want to appear inside the larger Context Zone.

2. To group these items, choose Shape, Grouping, then Group.

3. To name your group, choose Format, then Special, then enter your name, then click OK.

To copy items on a form:

To copy any item or object in a form, use CNTL+Drag.

To create an Image Snippet (see FIG. 10):

1. Drag an Image Snippet onto the drawing page from the VI JOE Fields stencil to create an Image Snippet field. This field will be captured as an image by WorkOnce.

2. To alter the size or shape of the Image Snippet field, drag one of the green handles squares on the panels.

To create a Data Field Comb (see FIG. 11):

1. Drag a comb onto the drawing page from the VI JOE Fields stencil to create the data fields you want.

2. You can add or delete boxes from the comb by simply dragging the side panels to the left or right.

Note: You cannot add or delete boxes from data field combs that deal with dates, phone numbers, social security numbers, or time. These combs (below) do not have green handles on their side panels. See FIG. 12.

To set Field Attributes for objects:

A Microsoft Visio drawing is more than a picture—it's a valuable medium for storing data. A shape can act as a visual database field that stores data you can retrieve in a report. For example, a shape in a flowchart can store data about the cost, duration, and resources involved in the process the shape represents.

Custom properties are stored in their own section of the shape's ShapeSheet spreadsheet. You can add fields using the Define Custom Properties dialog box. To store data with a Visio shape, add custom properties to shapes so that others can enter custom-property data.

1. Select your field, then choose Shape, then Custom Properties.

2. From the options, select the appropriate custom property.

KeyFlag specifies that this data field is a searchable field in the document viewer and editor.

RequiredFlag specifies that the data field is required, causes the verifier to show an exception if the field is blank.

LabelFlag specifies that this data field is part of the label for the page in the document viewer and editor.

VerifyFlag specifies that this data field should be autoverified regardless of the setting in the admin tab.

Rangelow specifies the low value for range checking on numeric fields.

Rangehigh specifies the high value for range checking on numeric fields.

Using the Stencil

To create a Radio Button table (see FIG. 13):

1. Drag the Radio Button table shape onto the drawing page from the Smart Controls stencil.

2. Drag the right square green handle to add columns.

3. Drag the bottom square green handle to add rows.

4. Radio Button tables are automatically grouped.

To create a Radio Button list (see FIG. 14):

1. Drag the Radio Button list shape onto the drawing page from the Smart Controls stencil.

2. Drag the right square green handle to expand the text area of the list item.

3. Drag the bottom square green handle to add list items.

4. Radio Button lists are automatically grouped.

Using the Form Shapes stencil

The Form Shapes stencil provides you with elements that can be used to enhance the esthetic quality of your form. These elements are not designed to capture data.

To open Form Shapes stencil:

1. Choose File, New, Forms and Charts, then Form Design. This stencil will give you more tools with which to design your form.

2. These form shapes are designed for cosmetic use only. They are not designed for data capture.

To add text boxes to a form:

1. Drag an Info Box, Shaded Box, or Reversed Text shape onto the drawing page from the Forms Shapes stencil.

2. Drag a side selection handle to resize the shape. NOTE The height of the Info Box shape is fixed.

3. To modify the text, select the shape, and then type the new text.

To add information lines to a form:

1. Drag an Info Line shape onto the drawing page from the Forms Shapes stencil.

2. Drag a selection handle on the right or left side of the shape to change the length of the line.

3. To modify the label text, select the shape, and then type the new text.

To create columns in a form:

1. Drag a column shape or line shape onto the drawing page from the Forms Shapes stencil.

2. To increase the height or width (spacing) of the columns, drag a selection handle. Preset columns and multiple lines remain equally spaced when you resize the width.

Tip: You can't change the number of columns for an individual 5- or 10-column shape, nor the number of lines for a Double or Triple Line shape, but you can overlap several column or line shapes to show different numbers of columns.

To create rows in a form:

1. Drag a column shape or line shape onto the drawing page from the Forms Shapes stencil.

2. Rotate the shape to a horizontal orientation by choosing Shape>Rotate Right.

3. To increase the height or width (spacing) of the columns, drag a selection handle. Preset columns or multiple lines remain equally spaced when you resize the width.

Tip: You can't change the number of rows for an individual 5- or 10-column shape, nor the number of lines for a Double or Triple Line shape, but you can overlap several column or line shapes to show different numbers of rows.

To add a grid to a form (see FIG. 15):

1. Drag the Grid shape onto the drawing page from the Forms Shapes stencil.

2. Drag a selection handle on the right or left side of the grid to change the numbers of columns in the grid. Drag a selection handle on the top or bottom of the grid to change the numbers of rows in the grid.

3. Drag control handles (green boxes) to adjust the first column width (this is the header column), the row height, and the other column widths.

The following refer to FIG. 15:

A Drag to change the row height.

B Drag to change the width of the first column.

C Drag to change the column width.

D Drag to increase or decrease the number of columns.

E Drag to increase or decrease the number of rows in the grid.

4. To add text, click the first column, and then type. Press Enter to move to the next row.

Duplicating lines and boxes

To quickly duplicate, align, and offset repeating elements in a form:

1. Drag a shape (such as a line) onto the drawing page from the Forms Shapes stencil.

2. Format and size the element the way you want to, and then select it.

3. Hold down the Ctrl key, and then drag to where you want the copy. Release the mouse button and Ctrl key.

4. Press F4 for each additional copy you want.

Tip: You can't change the number of columns for an individual 5- or 10-column shape, nor the number of lines for a Double or Triple Line shape, but you can overlap several column or line shapes to show different numbers of columns.

Adding text block and border shapes to a form:

1. Drag text block shapes (8 pt, 10 pt, or 18 pt) onto the drawing page from the Forms Shapes stencil to add text to various parts of the form.

2. Drag border shapes onto the drawing page to create borders for various parts of the form (including a border for the form itself).

3. Press Shift+Ctrl, and then click to zoom in, so that you can align parts of the form framework with one another and with the border.

To align shapes to a primary shape:

1. If you don't see the rulers, make sure View >Rulers is selected.

2. Select the shape you want to use as the primary shape, and to which you want to align other shapes, and then Shift+click to select the shapes you want to align to it.

3. Choose Tools, then Align Shapes.

4. Select the alignment options you want. Each alignment option is represented by an illustration. Choose an Up/Down Alignment, a Left/Right Alignment option, or one of each. To cancel the selection of either Alignment option, click the red X in that section.

5. To create a guide and glue the shapes to it, check Create Guide And Glue Shapes To It. If you choose this option, you can move all the shapes and maintain their alignment by selecting and moving the guide.

6. Click OK.

Notes: When you move the shapes, faint lines on the vertical and horizontal rulers indicate where on the drawing page you're moving the shapes. You can also click the arrow next to the Align Shapes button on the Action toolbar. Then, click one of the buttons depicted in FIG. 16.

To align shapes to a guide point:

1. If you don't see the rulers, make sure View >Rulers is selected.

2. Point to the crossbar at the intersection of the two rulers, and then drag to where you want the guide point. The guide point appears as two blue crossed lines.

3. Position shapes you want to align with their centers, selection handles (for 2-D shapes), or endpoints (for 1-D shapes) on the guide point.

Notes: When you move the shapes, faint lines on the vertical and horizontal rulers indicate where on the drawing page you're moving the shapes.

By default, the ruler zero point is at the lower-left comer of the drawing page. Sometimes you may want to change the position of the zero point. For example, you might want to measure the distances between shapes that aren't near the current zero point.

Snap behavior and automatic alignment

You can rely on snap behavior to position and align shapes exactly. See FIG. 17. Snapping pulls shapes to one another or to ruler subdivisions, grid lines, guides, or guide points so you can control placement and alignment. You can control what types of objects shapes snap to and the snap strength, which is the amount of pull that an object exerts.

To add colored backgrounds to parts of a form:

1. Open the Form drawing that you want to modify by doing one of the following:

Choose File, New, Forms And Charts, then Form Design to open the Form Design solution. Choose File, Open, and then open a Form drawing that you previously saved.

2. Click the rectangle tool (rectangle icon) on the Standard toolbar.

3. Draw a rectangle the size of the section of the form you want to color. (Before you attempt to draw the rectangle, make sure no other shapes on the form are selected.)

4. Choose the pointer tool on the Standard tool bar.

5. Choose Format, then Fill. Under Fill, choose the color you want, and then click OK.

6. Choose Shape, then Send To Back to put the background rectangle behind the text and other shapes in the section of the form.

Date information in forms

The Date/Time/Page shape is one of several title block shapes that you can use to give users more information about your drawing or form.

Use the Date/Time/Page shape to keep track of the creation date, last edited date, last printed date, or current date of a form.

By default, when you drag the Date/Time/Page shape on the drawing page, it displays the date and time you created the form. You can also set the Date/Time/Page shape to display the current date and time each time you open the drawing.

To set the Date/Time/Page shape to reflect the current date and time:

1. Drag a Date/Time/Page shape onto the drawing page from the Forms Shapes stencil.

2. Select the Date/Time/Page shape in your drawing. Choose Edit>Open Date/Time/Page.

3. Click the date numbers (not the word Date), and then choose Insert>Field.

4. Under Category, click Date/Time.

5. Under Field, click Current Date, and then click OK.

6. Click the time numbers (not the word Time), and then choose Insert>Field.

7. Under Field, click Current Time, and then click OK.

8. Click the close box to close the group window and return to the drawing.

Saving your form and publishing it

To save a drawing file for the first time

1. Choose File, Save (or File), then Save As.

2. For File Name, type a name for the drawing file.

3. Under Save In, open the folder in which you want to save the file.

4. Click Save.

Notes: To quickly save changes to a file you've already saved, click the Save button (floppy disk icon) on the Standard toolbar or press Ctrl+S. By default, existing files are saved in the format in which they were opened. To save in a different format, including earlier versions of your Microsoft Visio product, use File, then Save As.

To publish a form to VI Joe

The VI JOE system does not have a user interface. The user can communicate with the system via email. The user will email a Visio document of their form set to a specified email address. All email at this address is processed and the database on the server is modified directly to have the data necessary to use the forms.

When processing is completed, a copy of the Visio document is returned to the user, preferably with Form ID bubbles and Form Numbers added. This is the version that the user should print for use. The system will verify the incoming email address against a database of permissible users. Invalid users are rejected and an error message is sent to the user, the appropriate personnel, and to a Public Folder on the server for logging purposes.

Preferred Field Spacing Rules

| | mm | inches | 32nds | inches |
|---|---|---|---|---|
| Comb Width | 5 | 0.19685 | 6 | 0.1875 |
| Char. Spacing | 0.7 | 0.02756 | 1 | 0.03125 |
| Separator Height | 3 | 0.11811 | 4 | 0.125 |
| Comb Height | 7.5 | 0.29528 | 9 | 0.28125 |
| Field Spacing | 4 | 0.15748 | 4 | 0.125 |
| Field Text Spacing | 2 | 0.07874 | 2 | 0.0625 |

Form Numbers and Page ID Bubbles

The Form Number is generated automatically by VI JOE. The number is preferably a twelve-character number composed of two parts separated by a hyphen. The first part is formatted as YYMMDDXXX where YY is the year, MM is the month, DD is the day and XXX is an incrementing number for that day. The second part is the page number ranging from 01 to 52. The form number is placed vertically down the right hand side of the form, centered vertically, ¼″ off the right edge of the paper and printed in 10 pt font.

The Page ID bubbles are added automatically by VI JOE. These bubbles are preferably placed down the left hand side of the page. The first column of 26 bubbles is placed ¼″ from the left edge of the paper. The second column of 26 bubbles is placed 9/16″ from the left edge of the paper. The first row of bubbles is placed 2″ from the top edge of the paper. Each successive row is placed 5/16″ below the previous row. Measurements are to the top or left edge of the bubbles. Row spacing is measured from the top of one bubble to the top of the next bubble.

The Form Number and the Page ID bubbles create required margins of ⅞″ on the left and 7/16″ on the right side. Top and bottom margins can be set by the user to accommodate the target printer. Recommended margins are ¼″ top margin and bottom margin of ¼″ for laser printers and ⅝″ for ink jet printers.

The initial Visio stencil has an object for each of the different data types. These are generic items that create new fields in the database. Additional stencils will eventually be created that contain specific data fields so that data can easily be aggregated across form sets.

Supported Data Types:

Radio Button; Check Box; Uppercase Letters; Mixed Case Letters; Alphanumeric; Numeric; Uppercase Alphanumeric; Date Medium (MMDDYY); Date Long (MMDDCCYY); Date Short (MMYY); Multiselect Radio Button; Duration (weeks months years) (WWMMYY); Duration (years months) (YYMM); Date (CCYY); Time (HH:MM); Date Medium (YYMMDD); Phone Number; Social Security Number; Decimal Number; and Image Snippet.

Command Summary

Commands are case insensitive. Each command is on a separate line in the email. The order of commands is not significant. The placement of the attachment icon is not significant. Unrecognized text in the email will return a warning to the user in the reply email, but it will not prevent the email from being processed.

Formset—Optional, designates the name of the form set. If not present, it will default to the user's email address plus the form set number.

User—Optional, designates the name of the user for the form set (may be repeated, to create several users). If not used, a new user is created named “formsetXXX” with access to the form set.

Merge—Optional, tells I JOE to merge new forms with an existing form set. Requires the Formset command. If not used, a new form set is created.

First Page—Optional, designates the starting page number for the form set. This is used when merging new forms into an existing form set. Defaults to one more than the number of pages in the form set.

Test Only—This command tells VI Joe to test the validity of the form set without creating the database. This allows a user to test their work for accuracy without clogging up the database with partially completed forms.

Dump Shapes—This command causes VI Joe to return a data dump of all the shapes on each page of the document. This is useful in tracking down field duplication errors.

Preferred External Interface Requirements

The software is preferably a C++ program with a COM object that will process Visio documents. An email account is set up with a macro that is triggered on receipt of new mail. The incoming mail message is moved to a public folder for a listener to retrieve.

Sort Ordering

VI Joe preferably sequences the fields in a top down left right order. It does not include the text of a shape in determining the order—only the data collection shape. It uses the bounding rectangle to determine the order. At each level of grouping, the objects are sorted top-down left-right. Objects are assumed to form lines of data entry. As such, the bounding rectangle is used to determine the objects position relative to other objects. A shape that is entirely above another shape will come before it. If, when comparing two shapes, one shape encompasses the other—i.e., the top of one shape is above the top of the other and the bottom is below the other—then the shapes are considered to be on the same line and are sorted left to right.

Sort ordering can be affected by careful use of Visio grouping commands. Sorting is performed among objects at the same level in the Visio object tree. All top level objects are processed first and sorted among themselves. Objects that are within groups are sorted among the members of the group.

Error Messages

VI Joe preferably returns all error messages as text in the body of an email. There are two main categories of messages. Those that come from the listener and those that come from the VI Joe Object. Listener error messages primarily concern the email itself. VI JOE Object messages concern the actual form design.

Messages returned by the listener object:

| Message | Meaning and Resolution |
|---|---|
| Error - Invalid user | The email address of the user who |
| account. Please contact | submitted the email is not listed in the |
| sales to create a valid | Client List public folder. Add the user's |
| user account. | email address to the list. |
| | Another possibility is that the VI Joe |
| | Outlook profile is not set up to use the |
| | Client List as an address book. |
| Error - Missing Visio | An email to VI Joe must contain one and |
| document attachment. | only one Visio attachment. VI Joe |
| | recognizes an attachment as a Visio |
| | document by the VSD extension. |
| Error - Too many attached | An email to VI Joe must contain one and |
| Visio documents. Only one | only one Visio attachment. VI Joe |
| Visio document can be | recognizes an attachment as a Visio |
| processed per email. | document by the VSD extension. |
| Error - Missing formset | The FORMSET command was included in |
| name. | the email, but the name of the formset was |
| | left blank. The name must follow the |
| | command on the same line. |
| Error - Formset name ‘% s’ | Shorten the formset name to less than 64 |
| is too long. | characters. |
| Maximum length is 64 | |
| characters. | |
| Error - Too many formset | The FORMSET command was encountered |
| names specified. Only one | more than once in the email. Remove the |
| formset can be created | extra commands. |
| per email. | |
| Error - Missing user name. | The USER command was included in the |
| | email, but the name of the user was left |
| | blank. The name must follow the command |
| | on the same line. |
| Error - User name ‘% s’ is | Shorten the user name to less than 32 |
| too long. Maximum length | characters. |
| is 32 characters. | |
| Error - Missing first page | The FIRST PAGE command was included |
| number. | in the email, but the page number was left |
| | blank. The starting page number must |
| | follow the command on the same line. |
| Error - ‘% s’ is not a | The FIRST PAGE command was included |
| valid first page number. | in the email, but the page number was not a |
| | number. The starting page number must be |
| | digits only and follow the command on the |
| | same line. |
| Error - First page % d is | The FIRST PAGE command was included |
| out of range. The range | in the email, but the page number was out |
| of valid values is 1 to 54. | of range. The starting page number must be |
| | between 1 and 54 and follow the command |
| | on the same line. |
| Error - First page is | The FIRST PAGE command was |
| specified more than once. | encountered more than once in the email. |
| | Remove the extra commands. |
| Invalid command | This is a warning that extraneous text was |
| ignored: ‘% s’ | found in the email and was ignored. This is |
| | typically due to a signature block in the |
| | email. |

Messages returned by the VI Joe Object

All shapes that are referenced in the error messages are described in one of two ways: shape named ‘%s’ with text ‘%s’ at (%g,%g); or shape named ‘%s’ with no text at (%g,%g). Where the first %s refers to the internal Visio name for the shape (this name is displayed on the Format-Special dialog box). The second %s refers to the text associated with the shape if the shape has text. The coordinates generally refer to the center of the shape.

Shapes can be quickly found using the Drawing Explorer window in Visio which allows shapes to be selected based on their name. This is especially useful for shapes that have no text and are called Sheet.NNN. Also using the Dump Shapes command will provide the user with a complete listing of all the shapes in the document. This listing can be used to easily see how fields are grouped together and help resolve grouping problems.

Tip: Grouping and ungrouping objects causes an empty group object to be created. If objects are selected by clicking and dragging a selection box, these invisible group objects are also selected and can cause grief. When ungrouping shapes, make sure to delete the invisible group object before regrouping.

Messages returned by the VI Joe object

| Message | Meaning and Resolution |
|---|---|
| Error - Margins were | The margins can not be violated by ANY |
| exceeded on page ‘% s’ by | shapes. Move and/or resize the offending |
| a % s. Margins are set at: | shape to be within the margins. The |
| Left: % g (% g) | numbers specified in the second |
| Right: % g (% g) | sentence of the error message specify |
| Top: % g (% g) | the current margin coordinates as |
| Bottom: % g (% g) | measured from the bottom left corner of |
| | the page. The numbers in parentheses tell |
| | the user the coordinates of the shape that |
| | is crossing the margins. Comparing |
| | these numbers allows the user to |
| | determine where the problem is. |
| | Sometimes the margin is exceeded by |
| | a shape's text box which is too large. |
| | Reducing the size of the text box |
| | can resolve this problem. An important |
| | point to remember is that a shape |
| | has a text box even if the text is |
| | set to blank. This can still cause |
| | an error. |
| Error - The shape ‘% s’ and | Move the offending shapes further apart. |
| the % s on page ‘% s’ are too | This rule prevents a form from being so |
| close together for good | dense that the OCR engine won't be able |
| recognition. They must be at | to work well. |
| least % g inches apart. | |
| Error - The % s on page ‘% s’ | The default text associated with a stencil |
| does not have a valid name | master must be changed. The only |
| assigned to it. Change the | exceptions to this rule if the Phone |
| shape's text or its name. | Number and Social Security Number |
| | fields. All other fields must have |
| | names other than the name of the |
| | data type. This occurs more often |
| | with radio button groups when |
| | a user forgets to set the |
| | text of the group or creates the |
| | question as a separate text field. |
| | Visio will name groups by default |
| | Sheet.NNN. |
| Error - The field name ‘% s’ | Field names can not be reused on |
| is used more than once on | the page. This is probably due to having |
| page ‘% s’. | several fields called “Other” on |
| | the page. Change the names of the |
| | conflicting fields to be more |
| | descriptive and thereby unique. Also field |
| | names are taken from the text of the |
| | object. If the text contains a new |
| | line character, the name is truncated |
| | to only the first line of text. This does |
| | not apply to text that word wraps |
| | automatically. |
| Error - The radio button | Radio button options must be unique |
| option ‘% s’ is used more | within the group of radio buttons. |
| than once in the field called | Change the names of the conflicting |
| ‘% s’ on page ‘% s’. | options to be more descriptive and |
| | thereby unique. Also radio button option |
| | names are taken from the text of the |
| | object. If the text contains a new line |
| | character, the name is truncated to only |
| | the first line of text. This does not apply |
| | to text that word wraps automatically. |
| Error - A % s is in the dead | The dead zone is a rectangle at |
| zone on page ‘% s’. The field | (% g, % g)-(% g, % g) A data field |
| is too close to the clip on the | is in the dead zone. The message |
| digitizer pad (i.e., is in the | states which shape is in the dead zone as |
| “dead zone”). | well as the coordinates of the dead zone. |
| | These coordinates are measured from the |
| | top left corner of the page. Move and/or |
| | resize the offending shape to be outside |
| | the dead zone. This error unlike the |
| | margin error is only checking for the data |
| | entry portion of the shape. The text of a |
| | shape can be within the dead zone, though |
| | the use should be aware that the clip |
| | on the pad may obscure the text. |
| Error - Unable to connect | This can occur for a variety of reasons: |
| to database. | The DSN was not specified correctly |
| | (possibly misspelled) in the registry |
| | The DSN was not defined on the |
| | system as a system DSN |
| | The Oracle service name is not correct. |
| | The username/password is not correct. |
| Error - Formset ‘% s’ | The MERGE command was specified and |
| is not defined. | the formset does not already exist. |
| | Remove the MERGE command and |
| | resubmit the email or correct the |
| | formset name. |
| Error - Too many pages (% d) | The Visio document has too many pages. |
| in formset (Max = % d). | This means that the formset must be |
| | changed to be fewer pages or the |
| | algorithm for laying out the bubbles |
| | need to be rewritten. |
| Error - Overlapped page | The page number specified in the FIRST |
| numbers, first page is % d | PAGE command is overlapping with an |
| and there are already % d | existing page in the formset. Change the |
| pages in the formset. | page number in the FIRST PAGE number |
| | command. |
| Error - Database error, unable | This error means that a new formset name |
| to create formset ‘% s’ | could not be added to the database. |
| | Possibly due to security rights. |
| Error - Unknown error. | This means that the software threw an |
| | unknown exception. The Visio file could |
| | not be processed for some unknown |
| | reason. Debugging would be necessary to |
| | determine the exact nature of the |
| | exception. |
| Error - The checkbox for the | Increase the size of the checkbox to the |
| % s on page ‘% s’ is too | specified size. NOTE: The checkbox and |
| small for accurate recognition. | radio button shapes are already at the |
| The height and width of a | minimum size in the stencil. They should |
| checkbox must be at least | not be resized. |
| % g inches. | |
| Error - The comb for the % s | Increase the height of the comb to the |
| on page ‘% s’ is too short | specified height. |
| for accurate recognition. | NOTE: The combs in the stencil are |
| Combs must be at least % g | already the minimum height. They should |
| inches tall. | not be resized. |
| Error - The comb for the % s | Increase the width of the character cells of |
| on page ‘% s’ is too narrow | the comb to the specified width. |
| for accurate recognition. Each | NOTE: The combs in the stencil are |
| character position must be at | already the minimum width. They should |
| least % g inches wide. | not be resized. |
| Error - The characters for the | Increase the spacing of the character cells |
| % s on page ‘% s’ are too | of the comb to the specified width. |
| close together for accurate | NOTE: The combs in the stencil are |
| recognition. Each character | already the minimum width. They should |
| position must be separated | not be resized. |
| by at least % g inches. | |
| Error - The radio button % s | The specified radio button is an orphan. It |
| on page ‘% s’ is not part of | must be made to be part of a group or be a |
| a radio button group. | group of one. This is probably due to the |
| | user forgetting to group the radio buttons |
| | or incorrectly trying to add a radio button |
| | to an existing group. |
| Error - Radio button group | A non-radio button data field was grouped |
| ‘% s’ contains an invalid % s | together with the radio buttons. This is not |
| field called ‘% s’ on page | permitted. This is probably due to |
| ‘% s’. Radio button groups | grouping a data field associated with a |
| can only contain radio buttons | radio button in with the radio buttons. |
| of the same type. | Try grouping the radio buttons together |
| | first, then group the radio button group |
| | with the other data field. |
| Error - The % s on page ‘% s’ | A comb data type field is missing some or |
| is corrupted. | all of the user defined properties on its |
| | shape sheet. Remove the bad data field |
| | and recreate it from the VI Joe stencil. |
| Error - The radio button | A radio button groups contains both |
| option ‘% s’ in % s on page | multiselect radio buttons and regular |
| ‘% s’ is not the same type as | single selection radio buttons. Remove |
| the rest of the group. You can | the buttons with the wrong style and |
| not mix radio buttons with | recreate them with the correct items |
| multiselect options in the | from the VI Joe stencil. |
| same group.” | |
| Error - Caere engine error | The Caere engine returned an error while |
| creating zones (% d). | creating the ZON files for the formset. |
| | Refer to the Caere documentation on |
| | how to resolve the problem. |
| | NOTE: This should never occur unless |
| | Caere has not been installed properly. |
| Error - Radio button group | The radio button grouping is not correct. |
| ‘% s’ contains another group | The only things that can be in a radio |
| with text ‘% s’ on page ‘% s’. | button group are radio buttons. This |
| Radio button groups can only | problably occurred when attempting to |
| contain radio buttons. | add additional options to an existing |
| Subgroups are not | radio button group. Ungroup all the |
| permitted. | options and regroup them correctly. |

While the invention has been described with respect to the preferred embodiments, those skilled in the art will recognize that numerous variations and modifications may be made without departing from the scope of the invention. Accordingly, it should be clearly understood that the embodiments described above are not intended as restrictions on the scope of the invention, which is limited only by the following claims.

What is claimed is:

1. A method for creating a database for a form-based data collection system, comprising the steps of:
receiving from a user a document, wherein said document comprises data regarding shapes or graphical objects associated with information comprising one or more of the following: data type, data field size, and field location; and
populating a database from said information, using said data.

2. A method as in claim 1, wherein said shapes or graphical objects are dragged and dropped into said document.

3. A method as in claim 1, wherein said document comprises a plurality of pages.

4. A method as in claim 3, further comprising creating a form using said information associated with each page.

5. A method as in claim 4, wherein each form includes a form number.

6. A method as in claim 4, wherein each form includes a form identification bubble.

7. A method as in claim 4, further comprising the step of sending created forms via email to said user.

8. A method as in claim 1, wherein said document is a Visio document.

9. A method as in claim 4, wherein said document is received via email.

10. A method as in claim 4, wherein said document is a Visio document.

11. Software for creating a database for a form-based data collection system, comprising:
software for receiving from a user a document, wherein said document comprises data regarding shapes or graphical objects associated with information comprising one or more of the following: data type, data field size, and field location; and
software for populating a database from said information, using said data.

12. Software as in claim 11, wherein said shapes or graphical objects are dragged and dropped into said document.

13. Software as in claim 11, wherein said document comprises a plurality of pages.

14. Software as in claim 13, further comprising software for creating a form using said information associated with each page.

15. Software as in claim 14, wherein each form includes a form number.

16. Software as in claim 14, wherein each form includes a form identification bubble.

17. Software as in claim 14, further comprising software for sending created forms via email to said user.

18. Software as in claim 11, wherein said document is a Visio document.

19. Software as in claim 14, wherein said document is received via email.

20. Software as in claim 14, wherein said document is a Visio document.
